(19) United States
(12) Patent Application Publication
(10) Pub. No.: US 2006/0083202 A1
(43) Pub. Date: Apr. 20, 2006

(54) Method and system for implementing a single weight spatial multiplexing (SM) MIMO system without insertion loss

(76) Inventors: Mark Kent, Vista, CA (US); Vinko Erceg, Cardiff, CA (US); Uri M. Landau, San Diego, CA (US); Pieter Van Rooyen, San Diego, CA (US); Pieter Roux, San Diego, CA (US)

Correspondence Address: MCANDREWS HELD & MALLOY, LTD, 500 WEST MADISON STREET, SUITE 3400, CHICAGO, IL, 60661, US

(21) Appl. No.: 11/172,781

(22) Filed: Jun. 30, 2005

Related U.S. Application Data
(60) Provisional application No. 60/616,950, filed on Oct. 6, 2004.

(51) Int. Cl. H04Q 7/00

(52) U.S. Cl. 370/334

(57) ABSTRACT

Certain aspects of the method and system for implementing a single weight spatial multiplexing multi-input multi-output (MIMO) system without insertion loss may comprise receiving a plurality of spatially multiplexed communication signals for processing in a first reference processing path and at least a second processing path. At least one control signal may be generated that controls processing of at least a portion of the received plurality of spatially multiplexed communication signals in at least the second processing path. At least one phase adjustment signal may be generated from outside at least the second processing path. A phase of at least a portion of the received plurality of spatially multiplexed communication signals may be adjusted, which are processed in at least the second processing path via at least one generated phase adjustment signal.

### CROSS-REFERENCE TO RELATED APPLICATIONS/INCORPORATION BY REFERENCE

This patent application makes reference to, claims priority to and claims benefit from U.S. Provisional Patent Application Ser. No. 60/616,950 (Attorney Docket No. 16216US02) filed on Oct. 6, 2004.

This application makes reference to:
U.S. patent application Ser. No. ______ (Attorney Docket No. 16199US02) filed Jun. 30, 2005;
U.S. patent application Ser. No. ______ (Attorney Docket No. 16200US02) filed Jun. 30, 2005;
U.S. patent application Ser. No. ______ (Attorney Docket No. US02) filed Jun. 30, 2005;
U.S. patent application Ser. No. ______ (Attorney Docket No. 16202US02) filed Jun. 30, 2005;
U.S. patent application Ser. No. ______ (Attorney Docket No. 16203US02) filed Jun. 30, 2005;
U.S. patent application Ser. No. ______ (Attorney Docket No. 16204US02) filed Jun. 30, 2005;
U.S. patent application Ser. No. ______ (Attorney Docket No. 16205US02) filed Jun. 30, 2005;
U.S. patent application Ser. No. ______ (Attorney Docket No. 16206US02) filed Jun. 30, 2005;
U.S. patent application Ser. No. ______ (Attorney Docket No. 16207US02) filed Jun. 30, 2005;
U.S. patent application Ser. No. ______ (Attorney Docket No. 16208US02) filed Jun. 30, 2005;
U.S. patent application Ser. No. ______ (Attorney Docket No. 16209US02) filed Jun. 30, 2005;
U.S. patent application Ser. No. ______ (Attorney Docket No. 16210US02) filed Jun. 30, 2005;
U.S. patent application Ser. No. ______ (Attorney Docket No. US02) filed Jun. 30, 2005;
U.S. patent application Ser. No. ______ (Attorney Docket No. 16212US02) filed Jun. 30, 2005;
U.S. patent application Ser. No. ______ (Attorney Docket No. 16213US02) filed Jun. 30, 2005;
U.S. patent application Ser. No. ______ (Attorney Docket No. 16214US02) filed Jun. 30, 2005;
U.S. patent application Ser. No. ______ (Attorney Docket No. 16215US02) filed Jun. 30, 2005;
U.S. patent application Ser. No. ______ (Attorney Docket No. 16217US02) filed Jun. 30, 2005;
U.S. patent application Ser. No. ______ (Attorney Docket No. 16218US02) filed Jun. 30, 2005;
U.S. patent application Ser. No. ______ (Attorney Docket No. 16219US02) filed Jun. 30, 2005; and
U.S. patent application Ser. No. ______ (Attorney Docket No. 16220US02) filed Jun. 30, 2005.

The above referenced applications are hereby incorporated herein by reference in their entirety.

### FIELD OF THE INVENTION

Certain embodiments of the invention relate to spatial multiplexing in a MIMO system. More specifically, certain embodiments of the invention relate to a method and system for implementing a single weight spatial multiplexing multi-input multi-output (MIMO) system without insertion loss.

### BACKGROUND OF THE INVENTION

In most current wireless communication systems, nodes in a network may be configured to operate based on a single transmit and a single receive antenna. However, for many of current wireless systems, the use of multiple transmit and/or receive antennas may result in an improved overall system performance. These multi-antenna configurations, also known as smart antenna techniques, may be utilized to reduce the negative effects of multipath and/or signal interference may have on signal reception. Existing systems and/or systems which are being currently deployed, for example, CDMA-based systems, TDMA-based systems, WLAN systems, and OFDM-based systems such as IEEE 802.11 a/g/n, may benefit from configurations based on multiple transmit and/or receive antennas. It is anticipated that smart antenna techniques may be increasingly utilized both in connection with the deployment of base station infrastructure and mobile subscriber units in cellular systems to address the increasing capacity demands being placed on those systems. These demands arise, in part, from a shift underway from current voice-based services to next-generation wireless multimedia services that provide voice, video, and data communication.

The utilization of multiple transmit and/or receive antennas is designed to introduce a diversity gain and array gain and to suppress interference generated within the signal reception process. Such diversity gains improve system performance by increasing received signal-to-noise ratio, by providing more robustness against signal interference, and/or by permitting greater frequency reuse for higher capacity. In communication systems that incorporate multi-antenna receivers, a set of M receive antennas may be utilized to null the effect of (M−1) interferers. Accordingly, N signals may be simultaneously transmitted in the same bandwidth using N transmit antennas, with the transmitted signal then being separated into N respective signals by way of a set of N antennas deployed at the receiver. Systems that utilize multiple transmit and multiple receive antenna may be referred to as multiple-input multiple-output (MIMO) systems. One attractive aspect of multi-antenna systems, in particular MIMO systems, is the significant increase in system capacity that may be achieved by utilizing these transmission configurations. For a fixed overall transmitted power, the capacity offered by a MIMO configuration may scale with the increased signal-to-noise ratio (SNR).

However, the widespread deployment of multi-antenna systems in wireless communications, particularly in wireless handset devices, has been limited by the increased cost that results from increased size, complexity, and power consumption. The necessity of providing a separate RF chain for each transmit and receive antenna is a direct factor in the increased the cost of multi-antenna systems. Each RF chain generally comprises a low noise amplifier (LNA), a filter, a downconverter, and an analog-to-digital converter (A/D). In certain existing single-antenna wireless receivers, the single required RF chain may account for over 30% of the receiver's total cost. It is therefore apparent that as the number of transmit and receive antennas increases, the system complexity, power consumption, and overall cost may increase.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for implementing a single weight spatial multiplexing multi-input multi-output (MIMO) system without insertion loss, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF THE DRAWINGS

FIG. 1 is a block diagram of an exemplary single weight spatially multiplexed MIMO system with no insertion loss, in accordance with an embodiment of the invention.

FIG. 2 is a block diagram of an exemplary single weight single channel system for WCDMA, in accordance with an embodiment of the invention.

FIG. 3 is a flow diagram illustrating exemplary steps for processing signals in a receiver, in accordance with an embodiment of the invention.

FIG. 4A is a block diagram of an exemplary baseband processor that may be utilized within a MIMO system, in accordance with an aspect of the invention.

FIG. 4B illustrates an exemplary maximum-ratio combining (MRC) block, in accordance with an embodiment of the invention.

FIG. 5 is a block diagram of an exemplary receiver illustrating spatial multiplexing in a MIMO communication system that may be utilized in connection with an embodiment of the invention.

### DETAILED DESCRIPTION OF THE INVENTION

Certain aspects of a method and system for implementing a single weight spatial multiplexing multi-input multi-output (MIMO) system without insertion loss may comprise receiving a plurality of spatially multiplexed communication signals for processing in a first reference processing path and at least a second processing path. At least one control signal may be generated that controls processing of at least a portion of the received plurality of spatially multiplexed communication signals in at least the second processing path. At least one phase adjustment signal may be generated from outside at least the second processing path. A phase of at least a portion of the received plurality of spatially multiplexed communication signals may be adjusted, which are processed in at least the second processing path via at least one generated phase adjustment signal.

At least one amplitude adjustment signal may be generated from outside at least the second processing path. An amplitude of at least a portion of the received plurality of spatially multiplexed communication signals may be adjusted, which are processed in at least the second processing path via at least one generated amplitude adjustment signal. A first signal generated by a voltage controlled oscillator (VCO) may be mixed with at least the portion of received plurality of spatially multiplexed communication signals, which are processed in the first reference processing path. The first signal generated by the VCO may be modified with at least one generated control signal. At least one phase adjustment signal may be generated by modifying the first signal generated by the VCO with at least one generated control signal. At least one amplitude adjustment signal may be generated by modifying the first signal generated by the VCO with at least one generated control signal. The generated at least one control signal may comprise a single weight signal. At least one control signal may be generated by utilizing at least one optimization algorithm comprising at least one of a maximum signal-to-noise ratio (SNR) algorithm, a maximum signal-to-interference-and-noise ratio (SINR) algorithm, and a minimum bit error rate (BER) algorithm. Choosing which adaptive algorithm to use will be based upon the implementation complexity and performance tradeoffs between the different cost functions.

Spatial multiplexing (SM) may provide a mode of signal transmission predicated upon the use of multiple antennas at both a transmitter and a receiver, for example, in such a way that the capacity of a wireless radio link may be increased without correspondingly increasing power or bandwidth consumption. In a case in which N antennas are used at both a transmitter and a receiver, an input stream of information symbols provided to the transmitter is divided into N independent substreams. Spatial multiplexing contemplates that each of these N independent substreams may occupy the same “space-time channel”, for example, time slot, frequency, or code/key sequence, of the applicable multiple-access protocol. Within the transmitter, each substream may be separately applied to the N transmit antennas and propagated over an intervening multipath communication channel to a receiver. Error correction coding may be applied to each of the N streams separately or in a combined space-time methodology.

The composite multipath signals may then be received by an array of N or more receive antennas deployed at the receiver. At the receiver, a “spatial signature” defined by the N phases and N amplitudes arising at the receive antenna array for a given substream may be then estimated. Signal processing techniques may be then applied in order to spatially separate the received signals, which may allow the original substreams to be recovered and synthesized into the original input symbol stream. An overall system capacity of the order of the minimum of M and N, min(M,N), for example, may be achieved, where M may be the number of receive antennas and N may be the number of transmit antennas for flat fading channel conditions. The principles of spatially multiplexed communication and exemplary system implementations are further described in, for example, “Optimum combining for indoor radio systems with multiple users”, by J. H. Winters, IEEE Transactions on Communications, Vol. COM-35, No. 11, November 1987, which is hereby incorporated by reference in its entirety.

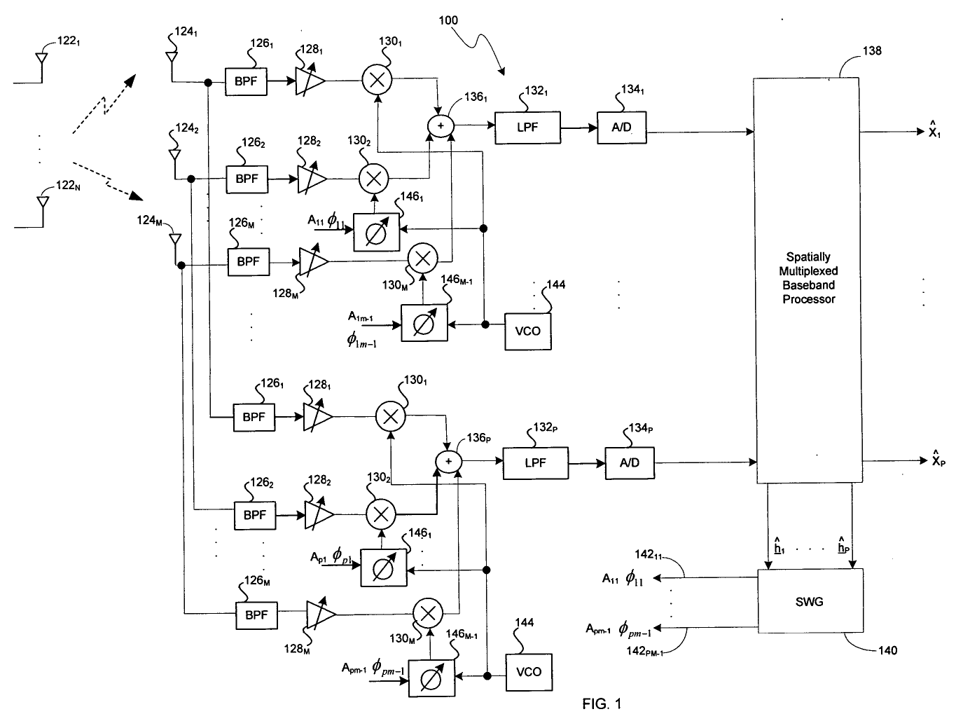

FIG. 1 is a block diagram of an exemplary single weight spatially multiplexed MIMO system with no insertion loss, in accordance with an embodiment of the invention. Referring to FIG. 1, there is shown a transceiver 100. The transceiver 100 may comprise a plurality of transmit antennas 122_{1 . . . N}, a plurality of receive antennas 124_{1 . . . M}, a plurality of band pass filters (BPFs) 126_{1 . . . M}, a plurality of low noise amplifiers (LNAs) 128_{1 . . . M}, a plurality of mixers 130_{1 . . . M}, a plurality of phase/amplitude shifter (PAS) blocks 146_{1 . . . M-1}. The transceiver 100 may further comprise a plurality of low pass filters (LPFs) 132_{1 . . . P}, a plurality of analog-to-digital (A/D) converters 134_{1 . . . P}, a plurality of summers 136_{1 . . . P}, a voltage controlled oscillator (VCO) 144, a spatially multiplexed baseband processor (SMBB) 138 and a single weight generator (SWG) 140.

The plurality of transmit antennas 122_{1 . . . N} may transmit processed spatially multiplexed RF signals to a plurality of receive antennas 124_{1 . . . M}. On the receive side, the plurality of BPFs 126_{1 . . . M} may comprise suitable logic, circuitry, and/or code and may be adapted to receive a plurality of spatially multiplexed RF signals from the plurality of receive antennas 124_{1 . . . M}. The plurality of BPFs 126_{1 . . . M} may then limit frequencies of the received spatially multiplexed signals to a pre-determined band of frequencies, and output that band of frequencies to the plurality of LNAs 128_{1 . . . M}. The plurality of LNAs 128_{1 . . . M} may comprise suitable logic, circuitry, and/or code and may be adapted to receive a plurality of input signals, amplify the signals and add phase shifts while introducing very little additional noise or distortion. The advantage of spatially multiplexing techniques lies in the fact that the same bandwidth is used for all the transmit data streams.

The plurality of PAS blocks 146_{1 . . . M-1} may be adapted to generate a plurality of phase and/or amplitude adjustment signals to the plurality of mixers 130_{2 . . . m}. The plurality of PAS blocks 146_{1 . . . M-1} may be adapted to receive a plurality of single weight (SW) control signals 142₁₁ to 142_{PM-1} from the SWG 140 to modify the phase and/or amplitude of the plurality of received spatially multiplexed communication signals. The plurality of PAS blocks 146_{1 . . . M-1} may be adapted to receive a phase and/or amplitude reference signal from the VCO 144. The VCO 144 may comprise suitable logic, circuitry and/or code that may be adapted to generate a phase and/or amplitude reference signal to the plurality of mixers 130_{1 . . . M}. The mixer 130₁ may comprise suitable logic, circuitry and/or code that may be adapted to receive a phase and/or amplitude reference signal from the VCO 144 and a portion of the received plurality of spatially multiplexed communication signals, which are processed in the first reference processing path. The mixer 130₁ may be adapted to generate an output signal to the summer 136₁. The plurality of mixers 130_{2 . . . M} may comprise suitable logic, circuitry and/or code that may be adapted to receive a phase and/or amplitude adjusted signal from the plurality of PAS blocks 146_{1 . . . M-1} and a portion of the received plurality of spatially multiplexed communication signals, which are processed in the second and subsequent processing paths.

The plurality of summers 136_{1 . . . P} may comprise suitable logic, circuitry and/or code that may be adapted to receive a plurality of input signals generated by the plurality of mixers 130_{1 . . . M} and generate an output signal to the plurality of LPFs 132_{1 . . . P}. The plurality of LPFs 132_{1 . . . P} may comprise suitable logic, circuitry and/or code and may be adapted to receive an input signal, limit the frequencies of the input signal to a pre-determined range of frequencies up to a certain upper limit frequency, and output that range of frequencies. The plurality of A/D converters 134_{1 . . . P} may comprise suitable logic, circuitry, and/or code that may be adapted to receive an analog signal from the plurality of LPFs 132_{1 . . . P} and generate a corresponding output digital signal, which may be communicated to the SMBB 138. The digital signal may sample the analog signal at a pre-defined rate.

The SMBB 138 may include, for example, suitable logic, circuitry and/or code that may be adapted to perform baseband processing. The SMBB 138 may perform, for example, demodulation, decoding and spatial demultiplexing on the received baseband signals. The SMBB 138 may be adapted to receive a plurality of digital RF signals from the plurality A/D converters 134_{1 . . . P} and generate a plurality of baseband combined channel estimates ĥ₁ to ĥ_{P} and a plurality of channel estimates \hat{X}₁ to \hat{X}_{P} of the original channel over which the input signals X₁ to X_{P} propagate. The spatial multiplexing processor 138 may be adapted to separate the different space-time channels utilizing a Bell Labs Layered Space-Time (BLAST) algorithm, for example, by performing sub-stream detection and sub-stream cancellation. The capacity of transmission may be increased almost linearly by utilizing the BLAST algorithm and assuming close to perfect channel estimation and cancellation.

The SWG 140 may include, for example, suitable logic, circuitry and/or code that may be adapted to determine the phase and/or the amplitude utilized in combining the received spatially multiplexed communication signals from the plurality of receive antennas 124_{1 . . . M}. The SWG 140 may generate SW control signals that may be utilized to tune the amplitude and phase shifters of the PSLNA blocks 130_{1 . . . M-1}. The SWG 140 may generate the SW control signals based on, for example, one or more of the following optimization algorithms: maximum signal-to-noise ratio (SNR), maximum signal-to-interference-and-noise ratio (SINR), minimum bit error rate (BER) and/or other optimization algorithms. The SWG block 140 may be adapted to receive a plurality of baseband combined channel estimates \hat{h}₁ to \hat{h}_{P} from the SMBB 138. The SWG block 140 may be adapted to generate a plurality of single weight control signals 142₁₁ to 142_{PM-1} to modify the phase and/or amplitude of the plurality of received spatially multiplexed communication signals.

In one aspect of the invention, the plurality of PAS blocks 146_{1 . . . M-1} may be utilized to shift the phase and/or the amplitude of the spatially multiplexed signals received at antennas 124_{2 . . . M} so that it is in-phase with the signal received at antenna 124₁. For example, the PAS block 146₁ may generate a phase and/or amplitude adjustment signal to the mixer 1302. The PAS block 146₁ may be adapted to receive a single weight (SW) control signal A₁₁, φ₁₁ 142₁₁, which may be generated by the single weight generator (SWG) 140. The PAS block 146₁ may then shift the phase and/or amplitude of the signal received at antenna 124₂ based on the received SW control signal 142₁₁ by generating a phase and/or an amplitude adjustment signal to be mixed with the portion of the received plurality of spatially multiplexed communication signals, which are processed in the second processing path. In this regard, the signals received at antennas 124₁ to 124_{M} for the first substream may be in phase at summer 136₁. The following sub streams (2 to P) may also be in phase at each of the corresponding summer blocks (2 to P). In addition, the LNAs 128₁ to 128_{M} may amplify the respective signals received from antennas 124₁ to 124_{M} so that a balanced gain is achieved for these signals at summer 136₁.

The plurality of PAS blocks 146_{2 . . . M-1} may each receive a single weight (SW) control signal A₁₂, φ₁₂ 142₁₂ to A_{1M-1}, φ_{1M-1} 142_{1M-1}, which may be generated by the single weight generator (SWG) 140. The phase and/or amplitude adjustment outputs generated by the plurality of PAS blocks 130_{2 . . . M-1} may be mixed with the received plurality of spatially multiplexed communication signals by the plurality of mixers 130_{2 . . . M}, which are processed in the second and subsequent processing paths. The outputs generated by the plurality of mixers 130_{2 . . . M} may be summed by the summer 136₁, which generates a RF signal to the LPF 132₁. The LPF 132₁ may comprise suitable logic, circuitry and/or code and may be adapted to receive an input signal, limit the frequencies of the input signal to a pre-determined range of frequencies up to a certain upper limit frequency, and output that range of frequencies. The A/D converter 134₁ may comprise suitable logic, circuitry, and/or code that may be adapted to receive an analog signal from the LPF 132₁ and generate a corresponding output digital signal, which may be communicated to the spatially multiplexed baseband processor (SMBB) 138. The SMBB 138 may be adapted to generate an estimate \hat{X}₁ of the original input signal X₁. Similarly, the SMBB 138 may be adapted to generate a plurality of estimates \hat{X}₂ to \hat{X}_{P} of the original input signals X₂ to X_{P}.

The SMBB 138 may be adapted to generate a plurality of baseband combined channel estimates \hat{h}₁ to \hat{h}_{P} to the SWG block 140. The SWG block 140 may be adapted to generate a plurality of SW control signals 142₁₁ to 142_{1M-1} to the plurality of PAS blocks 146_{1 . . . M-1} for the first RF path to generate the estimate \hat{X}₁ of the original input signal X₁. Similarly, the SWG block 140 may be adapted to generate a plurality of SW control signals 142₂₁ to 142_{PM-1} to the plurality of PAS blocks 146_{1 . . . M-1} for the successive RF paths to generate the plurality of estimates \hat{X}₂ to \hat{X}_{P} of the original input signals X₂ to X_{P}. The plurality of SW control signals may be generated utilizing one or more optimization algorithms, such as a maximum signal-to-noise ratio (SNR) algorithm, a maximum signal-to-interference-and-noise ratio (SINR) algorithm, and/or a minimum bit error rate (BER) algorithm.

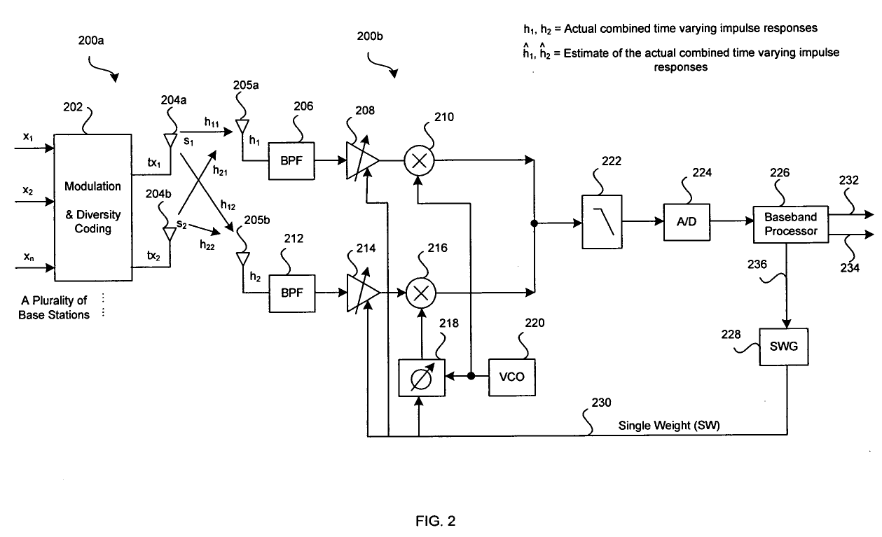

FIG. 2 is a block diagram of exemplary single weight single channel system for WCDMA, in accordance with an embodiment of the invention. Referring to FIG. 2, there is shown a transmitter section 200a and a receiver section 200b. The transmitter section 200a may comprise a modulation and diversity coding block 202 and transmit antennas 204a and 204b. Data inputs x₁, x₂, . . . xₙ, may be inputs to the modulation and diversity coding block 202. RF signals tx₁ and tx₂ may be output signals from the modulation and diversity coding block 202. The receiver section 200b may comprise receive antennas 205a and 205b, bandpass filters (BPF) 206 and 212, variable gain low-noise amplifiers (LNA) 208 and 214, mixers 210 and 216, a phase shifter block 218, a voltage controlled oscillator (VCO) 220, a low pass filter (LPF) 222, an analog-to-digital converter (ADC) 224, a digital baseband processor 226 and a single weight generator (SWG) 228. The combined time varying impulse responses of the propagation paths, or propagation channels, taken by the signals received by receive antennas, for example, the receive antennas 205a and 205b, may be represented by h₁ and h₂, respectively, per base station. The estimates of the combined time varying impulse responses h₁ and h₂ may be represented by ĥ₁ and ĥ₂, respectively, per base station.

In the transmitter section 200a, the modulation and diversity coding block 202 may be adapted to generate the RF signals tx₁ and tx₂ from the data inputs x₁, x₂, . . . , x₃. The transmit antennas 204a and 204b may transmit the RF signals tx₁ and tx₂, and the transmitted RF signals may be represented by s1 and s2, respectively.

In an exemplary embodiment of the invention, the phase shifter block 218 and the VCO 220 may be implemented outside the receive path of the receiver section 200b and mixers 210 and 216 may be implemented within the receive path of the receiver section 200b. In this manner, no insertion loss may be introduced by the phase shifter block 218 and the VCO 220 in the exemplary embodiment for single weight system.

The receiver section 200b may comprise suitable logic, circuitry, and/or code that may be adapted to receive RF signals, convert the RF signals to digital baseband signals, and process the digital baseband signals to output voice and/or data signals that may be suitable for further digital processing. Specifically, the BPFs 206 and 212 may comprise suitable logic and/or circuitry that may be adapted to receive an input signal, limit the frequencies of the input signal to a pre-determined band of frequencies, and output that band of frequencies. The LNAs 208 and 214 may comprise suitable logic and/or circuitry that may be adapted to amplify an input signal while introducing very little noise to the signal. The amplification provided by the LNAs 208 and 214 may be controlled by an input control signal. For example, since the signals received at a receive antenna may be as weak as six millivolts (6 mV), the LNA may be adapted to amplify these signals while adding very little additional noise to the signal being amplified. The mixers 210 and 216 may comprise suitable logic and/or circuitry that may be adapted to mix an input signal with a local oscillator signal to generate an output signal. The generated output signal may have a frequency that is a difference of the input signal frequency and the local oscillator frequency from the VCO 220.

The phase shifter block 218 may comprise suitable logic, circuitry, and/or code that may be adapted to receive an input signal, adjust the phase and/or the amplitude of the input signal, and then output the adjusted signal. The phase and/or the amplitude adjustment may be indicated by a control signal input, which may be a single weight signal. The VCO 220 may comprise suitable logic and/or circuitry that may be adapted to output a signal of a specific frequency which may be pre-determined, or controlled by a voltage signal input to the VCO 220.

The LPF 222 may comprise suitable logic and/or circuitry that may be adapted to receive an input signal, limit the frequencies of the input signal to a pre-determined range of frequencies up to a certain upper limit frequency, and output that range of frequencies. The ADC 224 may comprise suitable logic, circuitry, and/or code that may be adapted to receive an analog signal, sample the analog signal at a defined rate, and output the sampled digital signal.

The digital baseband processor 226 may comprise suitable logic, circuitry, and/or code that may be adapted to process a digital signal and generate output signals 236 that may be utilized to generate a single weight signal to control the phase and/or the amplitude of a signal being processed by the phase shifter block 218. These output signals 236 may be the channel estimates ĥ₁ and ĥ₂ and a timing signal T that may be generated to specify the location of signal clusters in time domain. The digital baseband processor 226 may also be adapted to output a voice signal 232 and/or a data signal 234, which may be further processed by, for example, a vocoder and a digital display processor, respectively. The SWG 228 may comprise suitable logic, circuitry, and/or code that may be adapted to generate a single weight signal that may be communicated to the phase shifter block 218 and/or to the LNAs 208 and 214.

In operation, the modulation and diversity coding block 202 may be adapted to modulate the input data signals x₁, x₂ . . . xₙ to generate the RF signals tx₁ and tx₂. The RF signals tx₁ and tx₂ may be transmitted via transmit antennas 204a and 204b, and the transmitted RF signals may be s₁ and s₂, respectively. A propagation path, or propagation channel, from a transmit antenna, for example, the transmit antenna 204a, to a receive antenna, for example, the receive antenna 205b, may have a corresponding time varying impulse response h_{xy}, where the subscripts x and y may indicate a specific transmit antenna and a specific receive antenna, respectively. For example, the transmitted RF signals s₁ and s₂ may propagate to the receive antennas 205a and 205b. The transmitted output signal s₁ may take a specific propagation channel from the transmit antenna 204a to the receive antenna 205a, and this propagation channel may have a time varying impulse response of h₁₁. Similarly, h₁₂ is the time varying impulse response of the propagation channel between the transmit antenna 204a and the receive antenna 205b for the signal s₁. Likewise, the transmitted output signal s₂ may propagate from the transmit antenna 204b to the receive antenna 205a, and that propagation channel may have a time varying impulse response of h₂₁, and a propagating channel from the transmit antenna 204b to the receive antenna 205b may have a time varying impulse response of h₂₂.

A transmitted signal, for example, the transmitted signal s₂, may take multiple propagation channels in propagating from a transmitting antenna, for example, the transmit antenna 204b, to a receiving antenna, for example, the receive antenna 205a. The multiple propagation channels may occur because the signal s₂ may propagate in a direct line from the transmit antenna 204b to the receive antenna 205a, and/or it may reflect off various objects, such as, for example, building, hills, trees, the ground, and moving vehicles, thereby taking different paths before being received by the receive antenna 205a. Each propagation channel may have a specific time varying impulse response. Each of the signals propagated via one of the multiple propagation channels may be called a multipath signal. Therefore, each propagation channel associated with each multipath signal received by the receive antenna 205b has an actual time varying impulse response. The time varying impulse responses associated with all the multipath signals may be combined together to form an aggregate time varying impulse response. For example, the time varying impulse response h₂₁ may be the combined time varying impulse responses associated with all multipaths for a transmitted signal, for example, s₂, that propagates from the transmit antenna 204b to the receive antenna 205a.

The time varying impulse response h₁ may be a combined time varying impulse response of the time varying impulse responses h₁₁ and h₂₁, and the time varying impulse response h₂ may be the combined time varying impulse response of the time varying impulse responses h₁₂ and h₂₂. A communication channel that utilizes diversity mode transmission may transmit from a plurality of transmitting antennas, for example, the transmit antennas 204a and 204b, and the signals transmitted may be received by a plurality of receive antennas, for example, the receive antennas 205a and 205b. Therefore, the time varying impulse response of that communication channel may be the time varying impulse response h₁ combined with the time varying impulse response h₂. The following equations may describe the combined time varying impulse responses h₁ and h₂:
h₁=h₁₁+h₁₂
h₂=h₂₁+h₂₂

The transmitted RF signals s₁ and s₂ may be received by the receive antennas 205a and 205b. The signals received by the receive antennas 205a and 205b may be bandpass filtered by BPFs 206 and 212, respectively, and then amplified by the LNAs 208 and 214, respectively. An amplified signal at an output of the LNA 208 may be mixed with the output of the VCO 220, and the output of the LNA 214 may be mixed with the output of the phase shifter block 218. The input to the phase shifter block 218 may be the output signal generated by the VCO 220.

The amplitude of the outputs of the LNAs 208 and 214 may be adjusted by the LNAs 208 and 214, respectively, based on the single weight (SW) signal 230 generated by the SWG 228. The amplitude and/or the phase of the output signal of the VCO 220 may be adjusted by the phase shifter block 218 based on the single weight (SW) signal 230 generated by the SWG 228. The signals at the outputs of the mixers 210 and 216 may be combined, and the resulting signal may be communicated to an input of the LPF 222. The LPF 222 may low-pass filter the combined signal, and a resulting filtered signal output of the LPF 222 may be converted to a digital signal by the ADC 224. The resulting digital output signal generated by the ADC 224 may be communicated to an input of the digital baseband processor 226. The digital baseband processor 226 may further process the digital signal to generate a voice signal 232 and a data signal 234. The voice signal 232 may be further processed by, for example, a vocoder, or other voice processing device or voice processing system, and the data signal 234 may be further processed by, for example, a display processor.

In addition, the baseband processor 226 may generate output signals 236 that may be utilized by the SWG 228 to generate a single weight (SW) signal 230. The output signals 236 may be the channel estimates ĥ₁ and ĥ₂ and a timing signal T that may be generated to specify the location of signal clusters in time domain. U.S. application Ser. No. ______ (Attorney Docket No. 16218US02) provides a detailed description of signal clusters and is hereby incorporated herein by reference in its entirety. The single weight (SW) signal 230 may communicate address and/or data to a plurality of blocks, for example, the VCO block 220 and the LNA blocks 208 and 214. The SWG 228 may communicate an address via the single weight (SW) signal 230, where the address may indicate a specific block. Data may then be communicated to, and received by, the addressed block. The data may indicate, for example, the amplification level to the LNA 208 or 214, or phase adjustment to the phase shifter block 218.

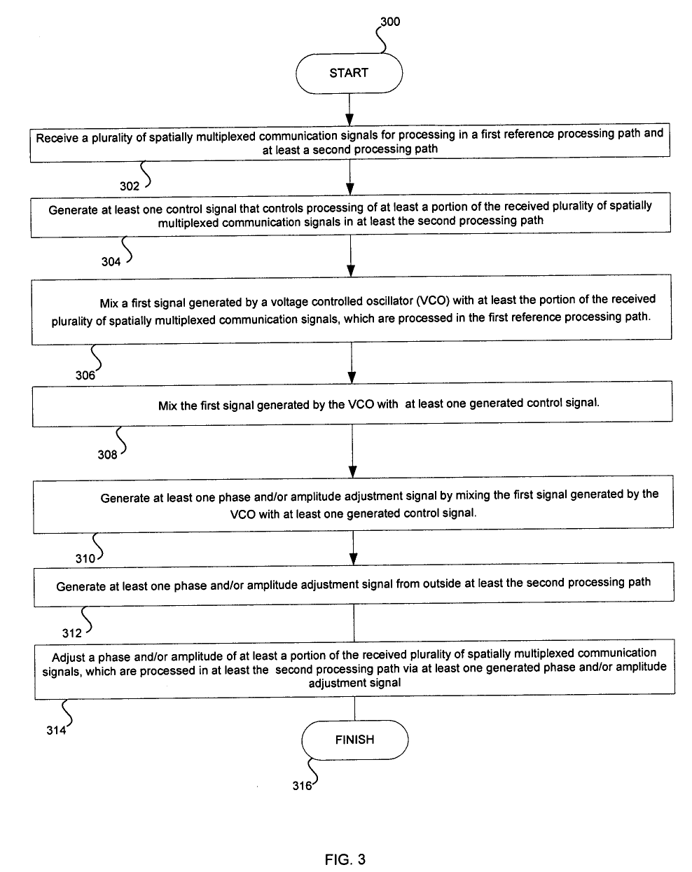

FIG. 3 is a flow diagram illustrating exemplary steps for processing signals in a receiver, in accordance with an embodiment of the invention. Referring to FIG. 3, the exemplary steps may start at step 300. In step 302, a plurality of spatially multiplexed communication signals for processing may be received in a first reference processing path and at least a second processing path. In step 304, a weight generator may generate at least one control signal that controls processing of at least a portion of the received plurality of spatially multiplexed communication signals in at least the second processing path. In step 306, a mixer may be adapted to mix a first signal generated by a voltage controlled oscillator (VCO) with at least the portion of received plurality of spatially multiplexed communication signals, which are processed in the first reference processing path. The first reference processing path comprises the receive antenna 1241, the BPF 126₁ and the LNA 128₁. In step 308, a phase adjuster may be adapted to mix the first signal generated by the VCO with at least one generated control signal. In step 310, at least one phase and/or amplitude adjustment signal may be generated by mixing the first signal generated by the VCO with at least one generated control signal. In step 312, at least one phase and/or amplitude adjustment signal may be generated from outside at least the second processing path. The second processing path comprises the receive antenna 124₂, the BPF 126₂ and the LNA 128₂. The subsequent processing paths comprise the plurality of receive antennas 124_{3 . . . M}, the plurality of BPFs 126_{3 . . . M} and the plurality of LNAs 128_{3 . . . M}. In step 314, a phase and/or amplitude of at least a portion of the received plurality of spatially multiplexed communication signals may be adjusted, which are processed in at least the second processing path via at least one generated phase and/or amplitude adjustment signal. The exemplary steps may end at step 316.

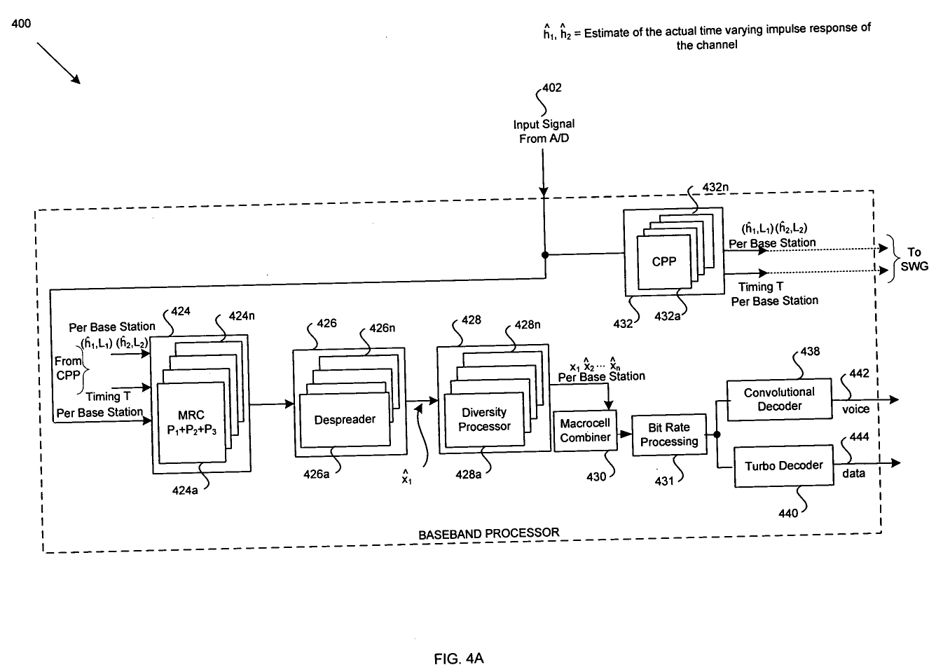

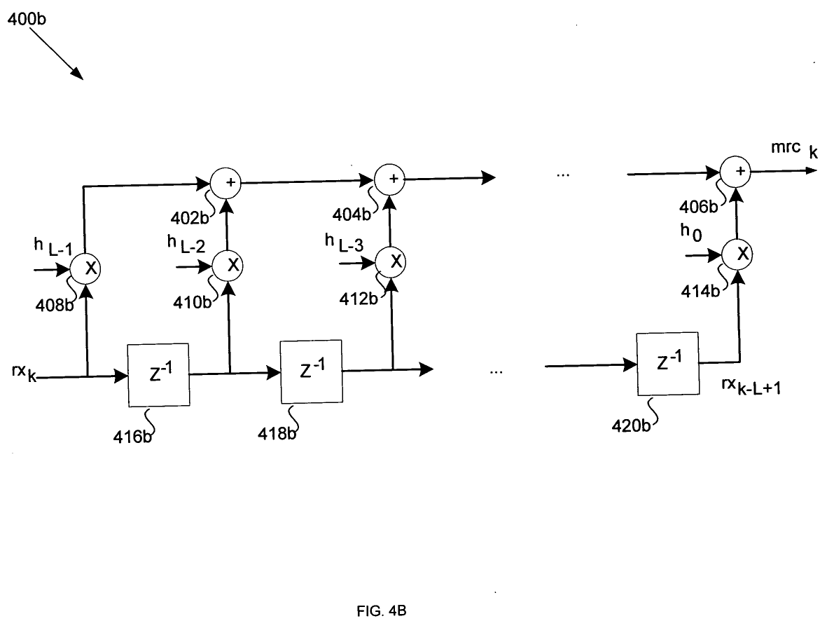

FIG. 4A is a block diagram of an exemplary baseband processor that may be utilized within a MIMO system, in accordance with an aspect of the invention. Referring to FIG. 4A, the baseband processor 400 may comprise a cluster path processor (CPP) block 432, a maximum ratio combining (MRC) block 424, a despreader block 426, a diversity processor block 428, a macrocell combiner block 430, a bit rate processing block 431, a convolutional decoder block 438, and a turbo decoder block 440.

U.S. application Ser. No. ______ (Attorney Docket No. 16218US02) provides a detailed description of signal clusters and is hereby incorporated herein by reference in its entirety.

The CPP block 432 may comprise a plurality of cluster processors that may be adapted to receive and process an input signal 402 received from a chip matched filter (CMF), for example. In the baseband receiver processor 400, the CPPs 432a, . . . , 432n within the CPP block 432 may be partitioned into pairs of processors, wherein each pair of processor may be adapted to track time-wise and estimate the complex phase and amplitude of the element in the cluster. A cluster may comprise an aggregate of received multipath signals with maximum (max) time difference that may be no more than 16×1/3.84e6 seconds, for example. Under these circumstances, the need for two processors may be derived from the fact that the WCDMA standard facilitates a receiving mode in which the transmitted signal is transmitted over two antennas, which necessitates the two processors. These receiving modes comprise close loop 1 (CL1), close loop 2 (CL2), and STTD. The CPP block 432 may be adapted to determine estimates of the entire transfer function of the channel and may recover channels on a per base station basis.

The CPP block 432 may be adapted to generate channel estimates ĥ₁ and ĥ₂ of the actual time varying impulse response of the channel per base station. The CPP 432 may also generate timing information T on per base station basis related to signals received by antennas at the receive side, such as antennas 205 and 207 of FIG. 2, for example. Corresponding lock indicators L_{1 and L}₂ may also be generated by the cluster processors. The lock indicators may provide an indication of which components in the corresponding estimates comprise valid component values. In one embodiment of the invention, cluster path processors 432a, . . . , 432n may be configured to operate in pairs when a transmitted signal is transmitted by two antenna, where the two antenna may be located in the same base station, or at different base stations. The channel estimates ĥ₁ and ĥ₂ of the actual time varying impulse response of the channel per base station, as well as lock indicators L1 and L2, and the timing information T per base station may be communicated to a single weight generation (SWG) block, for example, as well as to the maximum-ratio combining (MRC) block 424 for further processing. The channel estimates ĥ₁ and ĥ₂, the lock indicators L1 and L2, and the timing information T may be utilized by an SWG block for generating a single weight (SW) control signal for phase shifting of one or more signals received by receiver antennas.

The maximum-ratio combining block 424 may comprise suitable logic, circuitry and/or code to receive timing reference signals, T, and channel estimates and lock indicators, (ĥ1, L1) and (ĥ2,L2), from the corresponding cluster path processor block 432, which may be utilized by the maximum-ratio combining block 424 to process received signals from a chip matched filter (CMF) block, for example. The maximum ratio combining block 424 may utilize channel estimate components that are valid in accordance with the corresponding lock indicator. Channel estimate components that are not valid, in accordance with the corresponding lock indicator, may not be utilized. The maximum-ratio combining block 424 may be adapted to provide a combining scheme or mechanism for implementing a rake receiver which may be utilized with adaptive antenna arrays to combat noise, fading, and/or co-channel interference.

In accordance with an embodiment of the invention, the maximum-ratio combining block 424 may comprise suitable logic, circuitry, and/or code that may be adapted to add individual distinct path signals, received from the assigned RF channel, together in such a manner to achieve the highest attainable signal to noise ratio (SNR). The highest attainable SNR may be based upon a maximum ratio combiner. A maximum ratio combiner is a diversity combiner in which each of multipath signals from all received multipaths are added together, each with unique gain. The gain of each multipath before summing can be made proportional to received signal level for the multipath, and inversely proportional to the multipath noise level. Each of the maximum-ratio combining blocks may be also adapted to utilize other techniques for signal combining such selection combiner, switched diversity combiner, equal gain combiner, or optimal combiner.

In one embodiment of the invention, the assignment of fingers in the maximum-ratio combining block 424 may be based on channel estimates h1 and h2 from the cluster path processor block 432. The proportionality constants utilized in the maximum-ratio combining block 424 may be based on the valid channel estimates, ĥ1 and ĥ2, from the cluster path processor block 432.

The despreader (DS) block 426 may comprise a plurality of despreader blocks 426a, . . . , 426n. Each of the despreader blocks 426a, . . . , 426n may comprise suitable logic, circuitry, and/or code that may be adapted to despread received signals that may have been previously spread through the application of orthogonal spreading codes in the transmitter. Prior to transmission of an information signal, known as a “symbol”, the transmitter may have applied an orthogonal spreading code that produced a signal comprising a plurality of chips. The DS block 426 may be adapted to generate local codes, for example Gold codes or orthogonal variable spreading factor (OVSF) codes, that may be applied to received signals through a method that may comprise multiplication and accumulation operations. Processing gain may be realized after completion of integration over a pre-determined number of chips in which the symbol is modulated.

Following despreading at the receiver, the original symbol may be extracted. WCDMA may support the simultaneous transmission of a plurality of spread spectrum signals in a single RF signal by utilizing spreading codes among the spread spectrum signals which are orthogonal to reduce multiple access interference (MAI). The receiver may extract an individual symbol from the transmitted plurality of spread spectrum signals by applying a despreading code, which may be equivalent to the code that was utilized for generating the spread spectrum signal. Similarly to the CPP block 432 and the MRC block 424, the DS block 426 may be assigned on a per base station basis, with the MRC block 424 communicating with the DS block 426 that may be assigned to the same base stations.

The diversity processor 428, comprising a plurality of diversity processor blocks 428a, . . . , 428n, may comprise suitable logic, circuitry, and/or code that may be adapted to combine signals transmitted from multiple antennas in diversity modes. The diversity modes may comprise OL, CL1 and CL2. The diversity processor 428 may combine signals transmitted from multiple antennas that are located at the same base station. Similarly with the cluster path processors 432, the maximum-ratio combining blocks 424, and the despreader blocks 426, the diversity processors 428 may be assigned on a per base station basis, with the diversity processors 428 communicating with despreader blocks 426 that may be assigned to the same base stations.

The macrocell combiner 430 may comprise suitable logic, circuit and/or code and may be adapted to achieve macroscopic diversity. The macroscopic diversity scheme may be utilized for combining two or more long-term lognormal signals, which may be obtained via independently fading paths received from two or more different antennas at different base-station sites. The microscopic diversity schemes may be utilized for combining two or more short-term Rayleigh signals, which are obtained via independently fading paths received from two or more different antennas but only one receiving site.

The bit rate processing block 431 may comprise suitable logic, circuitry and/or code to process frames of data received from the macrocell combiner 430. The processing may further comprise depuncturing, and deinterleaving data in the received frame, and further determining a rate at which processed frames are communicated in output signals.

The convolutional decoder 438 may comprise suitable logic, circuitry and/or code that may be utilized to handle decoding of convolutional codes as indicated in the 3GPP specification. The output of the convolutional decoder 438 may be a digital signal, which comprises voice information, suitable for processing by a voice-processing unit. The turbo decoder 440 may comprise suitable logic, circuitry and/or code that may be utilized to handle decoding of turbo codes as indicated in the 3GPP specification. The output of the turbo decoder 440 may be a digital signal, which has data information, such that it may be suitable for use by a video display processor.

Referring to FIGS. 2 and 4A, in operation, the transmitter side 200a may be adapted to mix the input data signal x₁ with the code signal c₁ and generate the output signal, which may be transmitted via antenna 203 over different paths over the air. Each over the air path or channel has a corresponding time varying impulse response function h₁ and h₂. The channel estimates ĥ₁ and ĥ₂ provide estimates of the actual time varying impulse response of the channel over which the received signals are transmitted. The signal received by the antennas 205 and 207 may be bandpass filtered by BPFs 202 and 206, respectively, and amplified by the LNA 204 and the PSLNA block 208, respectively. In addition, the PSLNA block 208 may receive SW control signal 220 from the SWG block 218 and may adjust the phase of the signal received at antenna 207 based on the SW 220. In this regard, the signal received at antenna 207 may be in-phase with the signal received at antenna 205. In addition, the gains of the two signals received at antennas 205 and 207 may be adjusted so that there may be a gain balance at point 210 in the receiver side 200b.

The RF signal may then be processed by the DCR block 212 and may be further amplified, mixed with a VCO signal, and/or low pass filtered. The RF analog signal processed by the DCR block may be converted to a digital signal by the A/D 214. The digital output of the A/D 214 may be communicated as an input to the baseband processor 216. The baseband processor 216 may further process the input to generate a voice signal 222 and a data signal 224. The voice signal 222 may be further processed, for example, by a voice processing system or device, and the data signal 224 may be further processed by a display processor, for example. In addition, the baseband processor 216 may be adapted to generate signals that may be utilized by the SWG 218 in generating the signal SW 220.

The digital signal output from the A/D block 214 may be communicated as input signal 402 to the CPP block 432. For example, processor 432a may generate a set of channel estimates and lock indicators, (ĥ1,L1), and a timing reference signal T1. Processor 432b may generate a set a channel estimates and lock indicators, (ĥ2,L2), and a timing reference signal T2. Processor 432a and processor 432b may generate channel estimates and timing reference signals based on received signals from a single base station. There may be a deterministic relationship between the timing reference signals such that given, for example, T1, it may be possible to determine T2, and/or vice versa. In such case, only one timing reference signal, T, which may be based on at least one of T1 or T2, may be communicated to the maximum-ratio combining block 424.

The maximum-ratio combining block 424 may be adapted to utilize the channel estimates and lock indicators (ĥ1,L1), (ĥ2,L2) and timing information T per base station to assign rake fingers to received individual distinct path signals and to assign proportionality constants to each finger. Received individual distinct path signals may be processed in the maximum-ratio combining block 424 as signal clusters comprising a plurality of received individual distinct path signals. In an embodiment of the invention, the maximum-ratio combining block 424 may assign a time, T(n), to the nth grid element of the CPP 432, where the plurality of times T(n) may be based on the timing reference T. Given a time assignment, and a time offset, toff, a given CPP 432, n, may detect an individual distinct path signal that is received during a time interval starting at [T(n)−toff/2], and ending at [T(n)+toff/2].

The individual distinct path signals received collectively for each CPP 432 may constitute a signal cluster. The relationship of the values T(n) among the processing elements of the CPP 432 in the receiver may be such that T(n+1)−T(n) is equal to a constant value for values of n among the set of fingers. Thus, once T is determined, the timing relationships for the receipt of the plurality of individual distinct path signals constituent in the signal cluster may be determined. The time offset value, toff, may represent a time duration, which is at least as long as the period of time required for transmitting the plurality of chips contained in a symbol. For example, if the symbol comprises 16 chips, and the W-CDMA chip rate is 3.84×106 chips/second, then the time offset toff may be (16/3.84×106) seconds or approximately 4 microseconds.

Embodiments of the invention may not be limited to values of the difference T(n+1)−T(n) being constant among all n fingers in a rake receiver. However, each value, T(n), may be based on the timing reference signal, T.

The maximum-ratio combining block 424 may proportionately scale and add the received individual distinct path signals to produce a chip level output, which may be communicated to the despreader block 426. The despreader block 426 may be adapted to despread the chip level signal received from the maximum-ratio combining block 424 to generate estimates of the original transmitted signals. The diversity processor block 428 may be adapted to provide diversity processing and to generate output data estimates on a per base station basis. The macrocell combiner block 430 may achieve macroscopic diversity when a received signal has been transmitted by a plurality of base stations. The bit rate processing block 431 may perform processing tasks comprising depuncture and deinterleave on received frames of data that are communicated in received individual distinct path signals. The bit rate processing block 431 may determine a rate at which to communicate processed frames of data to the convolutional decoder block 438, and/or the turbo decoder block 440. The convolution decoder block 438 may be adapted to perform convolutional decoding on the voice portion of the signal generated from an output of the bit rate processing block 431. The turbo decoder block 440 may be adapted to perform turbo decoding on the data portion of the signal generated from an output of the bit rate processing block 431.

FIG. 4B illustrates an exemplary maximum-ratio combining (MRC) block, in accordance with an embodiment of the invention. Referring to FIG. 4B, the maximum-ratio combining (MRC) block 400b may comprise a plurality of adders 402b, . . . , 406b, a plurality of multipliers 408b, . . . , 414b, and a plurality of delay blocks 416b, . . . , 420b. In one embodiment of the invention, the MRC block 400b may receive a plurality of channel estimates hᵢₖ (i=0,1, . . . , L−1) from a corresponding cluster path processor block. For example, the MRC block 400b may receive estimate vectors ĥ1 and ĥ2 of the actual time varying impulse response of a channel, from a cluster path processor. Each of the estimate vectors ĥ1 and ĥ2 may comprise a cluster grid of channel estimates hᵢₖ (i=0,1, . . . , L−1), where L may indicate the width of the cluster grid of estimates and may be related to the delay spread of the channel.

In operation, the MRC block 400b may be adapted to implement the following equation:

$${mrc}_{k} = {\sum }_{i = 0}^{L - 1} {h}_{L - 1 - i} \cdot {rx}_{k - i} ,$$

where mrcₖ is the output of the MRC block 400b, hL−1−l is the plurality of channel estimates corresponding to a channel estimate vector, such as ĥ1 and ĥ2, and rxₖ is a filtered complex input signal. The MRC block 400b may be adapted to add individual distinct path signals together in such a manner to achieve a high signal to noise ratio (SNR) in an output signal mrcₖ.

The MRC block 400b may receive a filtered complex signal rxₖ from a chip matched filter (CMF), for example. The filtered complex signal rxₖ may comprise in-phase (I) and quadrature (Q) components of a received signal. Furthermore, the filtered complex signal rxₖ may be gated by cluster path processor (CPP) output strobes derived from a CPP timing reference, for example. Channel estimates hᵢₖ (i=0,1, . . . , L−1) may be applied to the CMF output rxₖ beginning with the last in time, hL−1, and proceeding with channel estimates hL−2, . . . , h0, utilizing multiplier blocks 408b, . . . , 414b, respectively. The filtered complex input signal rxₖ may be continuously delayed by delay blocks 416b, . . . , 420b. Each delayed output of the delay blocks 416b, . . . , 420b may be multiplied by the multiplier blocks 410b, . . . , 414b, respectively, utilizing corresponding channel estimates hᵢₖ. The outputs of the multipliers 402b, . . . , 406b may be added to generate the output signal mrcₖ, thereby implementing the above-referenced MRC equation.

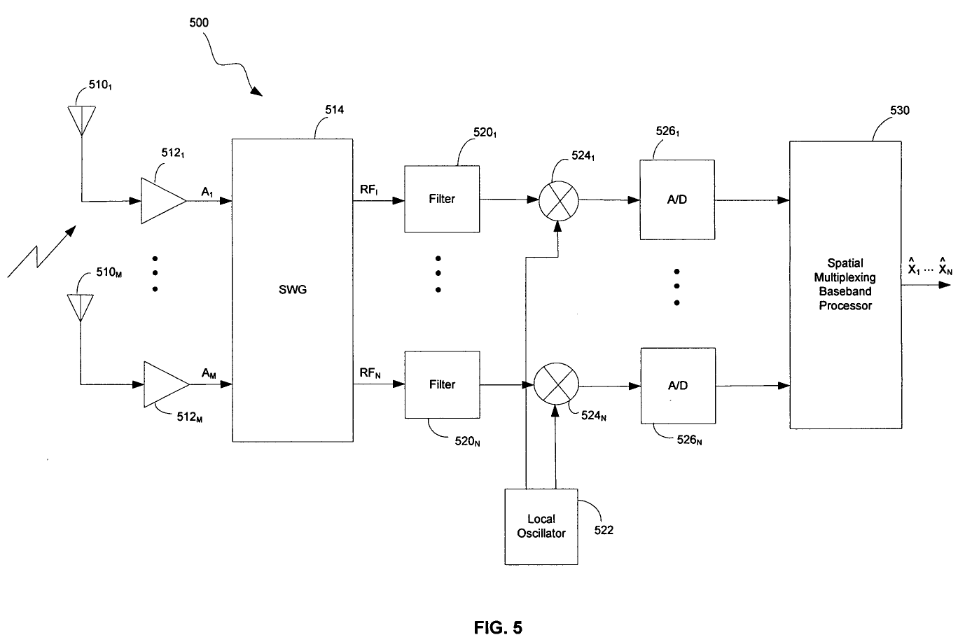

FIG. 5 is a block diagram of an exemplary receiver illustrating spatial multiplexing in a MIMO communication system that may be utilized in connection with an embodiment of the invention. Referring to FIG. 5, there is shown a receiver 500 that comprises a plurality of receive antennas 510_{1,2, . . . , M}, a plurality of amplifiers 512_{1,2, . . . , M}, a SWG block 514, a plurality of filters 520_{1,2, . . . , N}, a local oscillator 522, a plurality of mixers 524_{1,2, . . . , N}, a plurality of analog to digital (A/D) converters 526_{1,2, . . . , N} and a spatial multiplexing baseband processor SMBB 530.

The antennas 510_{1,2, . . . , M} may be adapted to receive the transmitted signals. The amplifiers 512_{1,2, . . . , M} may be adapted to amplify the M received input signals. The SWG block 514 may comprise a plurality of amplitude and phase shifters to compensate for the phase difference between various received input signals. Weights may be applied to each of the input signals A_{1 . . . M} to modify the phase and amplitude of a portion of the transmitted signals received by the plurality of receive antennas 512_{1 . . . M} and generate a plurality of output signals RF_{1 . . . N}. The plurality of filters 520_{1,2 . . . , N} may be adapted to filter frequency components of the RF substreams. The mixers 524_{1,2, . . . , N} may be adapted to downconvert the analog RF substreams to baseband. The local oscillator 522 may be adapted to provide a signal to the mixers 524_{1,2, . . . , N}, which is utilized to downconvert the analog RF substreams to baseband. The analog to digital (A/D) converters 526_{1,2, . . . , N} may be adapted to convert the analog baseband substreams into their corresponding digital substreams. The spatial multiplexing baseband processor SMBB 530 may be adapted to process the digital baseband substreams and multiplex the plurality of digital signals to generate output signals or symbols \hat{X}₁ . . . \hat{X}_{N} which may be estimates of the original spatial multiplexing sub-stream signals or symbols X₁ . . . X_{N}.

In operation, the MT RF signals transmitted by a plurality of transmitters may be received by a plurality of M receive antennas 510_{1,2, . . . , M} deployed at the receiver 500. Each of the M received signals may be amplified by a respective low noise amplifier 512_{1,2, . . . , M}. A plurality of weights may be applied to each of the input signals A_{1 . . . M} to modify the phase and amplitude of a portion of the transmitted signals received by the plurality of receive antennas 512_{1 . . . M}. A plurality of output signals RF_{1 . . . N} may be generated, which may be filtered by a plurality of filters 520_{1,2, . . . , N}. The resulting N filtered signals may then be downconverted to baseband utilizing a plurality of N mixers 524_{1,2, . . . , N}, each of which may be provided with a carrier signal that may be generated by a local oscillator 522. The N baseband signals generated by the mixers 524_{1,2, . . . , N} may then be converted to digital signals by a plurality of analog to digital (A/D) converters 526_{1,2, . . . , N}. The N digital signals may further be processed by a spatial multiplexing baseband processor SMBB 530 to generate an output signals \hat{X}₁ . . . \hat{X}_{N}, which are estimates of the original spatial multiplexing sub-stream signals or symbols X₁ . . . X_{N}.

Aspects of the system may comprise receiving a plurality of spatially multiplexed communication signals for processing by a plurality of receive antennas 128_{1 . . . M} in a first reference processing path and at least a second processing path. For example, a plurality of control signals A₁₁, φ₁₁ 142₁₁ to A_{PM-1}, φ_{PM-1}, 142_{PM-1}, may be generated by a weight generator SWG 140, where the control signals A₁₁, φ₁₁ 142₁₁ to A_{1M-1}, φ_{1M-1} 142_{1M-1} may be utilized to control at least a first of the plurality of received spatially multiplexed communication signals from the plurality of receive antennas 124_{1 . . . M}. A weight generator SWG 140 may generate at least one control signal that controls processing of at least a portion of the received plurality of spatially multiplexed communication signals in at least the second processing path. Circuitry may be adapted to generate at least one phase adjustment signal from outside at least the second processing path. Circuitry may be provided to adjust a phase of at least a portion of the received plurality of spatially multiplexed communication signals, which are processed in at least the second processing path via at least one generated phase adjustment signal.

Circuitry may be adapted to generate at least one amplitude adjustment signal from outside at least the second processing path. Circuitry may be provided to adjust an amplitude of at least a portion of the received plurality of spatially multiplexed communication signals, which are processed in at least the second processing path via at least one generated amplitude adjustment signal. A mixer 130 may be adapted to mix a first signal generated by a voltage controlled oscillator (VCO) 144 with at least the portion of received plurality of spatially multiplexed communication signals, which are processed in the first reference processing path. A phase adjuster 146 may be adapted to modify the first signal generated by the VCO 144 with at least one generated control signal. The system may further comprise circuitry that may be adapted to generate at least one phase adjustment signal by modifying the first signal generated by the VCO 144 with at least one generated control signal. Circuitry may also be provided to generate at least one amplitude adjustment signal by modifying the first signal generated by the VCO 144 with at least one generated control signal. The generated at least one control signal may comprise a single weight signal. The weight generator SWG 140 may generate at least one control signal by utilizing at least one optimization algorithm comprising at least one of a maximum signal-to-noise ratio (SNR) algorithm, a maximum signal-to-interference-and-noise ratio (SINR) algorithm, and a minimum bit error rate (BER) algorithm.

Accordingly, the present invention may be realized in hardware, software, firmware or a combination of hardware, software and/or firmware. Some embodiments according to some aspects of the present invention may be realized, for example, in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

Some embodiments according to some aspects of the present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for processing signals in a communication system, the method comprising:
receiving a plurality of spatially multiplexed communication signals for processing in a first reference processing path and at least a second processing path;
generating at least one control signal that controls processing of at least a portion of said received plurality of said spatially multiplexed communication signals in said at least said second processing path;
generating at least one phase adjustment signal from outside said at least said second processing path; and
adjusting a phase of said at least a portion of said received plurality of said spatially multiplexed communication signals, which are processed in said at least said second processing path via said at least one generated phase adjustment signal.

2. The method according to claim 1, further comprising generating at least one amplitude adjustment signal from outside said at least said second processing path.

3. The method according to claim 2, further comprising adjusting an amplitude of said at least a portion of said received plurality of said spatially multiplexed communication signals, which are processed in said at least said second processing path via said at least one generated amplitude adjustment signal.

4. The method according to claim 1, further comprising mixing a first signal generated by a voltage controlled oscillator (VCO) with said at least said portion of said received plurality of said spatially multiplexed communication signals, which are processed in said first reference processing path.

5. The method according to claim 4, further comprising modifying said first signal generated by said VCO with said at least one generated control signal.

6. The method according to claim 5, further comprising generating said at least one phase adjustment signal by modifying said first signal generated by said VCO with said at least one generated control signal.

7. The method according to claim 6, further comprising generating at least one amplitude adjustment signal by modifying said first signal generated by said VCO with said at least one generated control signal.

8. The method according to claim 1, wherein said generated at least one control signal comprises a single weight signal.

9. The method according to claim 1, further comprising generating said at least one control signal utilizing at least one optimization algorithm comprising at least one of a maximum signal-to-noise ratio (SNR) algorithm, a maximum signal-to-interference-and-noise ratio (SINR) algorithm, and a minimum bit error rate (BER) algorithm.

10. A machine-readable storage having stored thereon, a computer program having at least one code section for processing signals in a communication system, the at least one code section being executable by a machine for causing the machine to perform steps comprising:
receiving a plurality of spatially multiplexed communication signals for processing in a first reference processing path and at least a second processing path;
generating at least one control signal that controls processing of at least a portion of said received plurality of said spatially multiplexed communication signals in said at least said second processing path;
generating at least one phase adjustment signal from outside said at least said second processing path; and
adjusting a phase of said at least a portion of said received plurality of said spatially multiplexed communication signals, which are processed in said at least said second processing path via said at least one generated phase adjustment signal.

11. The machine-readable storage according to claim 10, further comprising code for generating at least one amplitude adjustment signal from outside said at least said second processing path.

12. The machine-readable storage according to claim 11, further comprising code for adjusting an amplitude of said at least a portion of said received plurality of said spatially multiplexed communication signals, which are processed in said at least said second processing path via said at least one generated amplitude adjustment signal.

13. The machine-readable storage according to claim 10, further comprising code for mixing a first signal generated by a voltage controlled oscillator (VCO) with said at least said portion of said received plurality of said spatially multiplexed communication signals, which are processed in said first reference processing path.

14. The machine-readable storage according to claim 13, further comprising code for modifying said first signal generated by said VCO with said at least one generated control signal.

15. The machine-readable storage according to claim 14, further comprising code for generating said at least one phase adjustment signal by modifying said first signal generated by said VCO with said at least one generated control signal.

16. The machine-readable storage according to claim 15, further comprising code for generating at least one amplitude adjustment signal by modifying said first signal generated by said VCO with said at least one generated control signal.

17. The machine-readable storage according to claim 10, wherein said generated at least one control signal comprises a single weight signal.

18. The machine-readable storage according to claim 10, further comprising code for generating said at least one control signal utilizing at least one optimization algorithm comprising at least one of a maximum signal-to-noise ratio (SNR) algorithm, a maximum signal-to-interference-and-noise ratio (SINR) algorithm, and a minimum bit error rate (BER) algorithm.

19. A system for processing signals in a communication system, the system comprising:
a plurality of receive antennas that receive a plurality of spatially multiplexed communication signals for processing in a first reference processing path and at least a second processing path;
a weight generator that generates at least one control signal that controls processing of at least a portion of said received plurality of said spatially multiplexed communication signals in said at least said second processing path;
circuitry that generates at least one phase adjustment signal from outside said at least said second processing path; and
circuitry that adjusts a phase of said at least a portion of said received plurality of said spatially multiplexed communication signals, which are processed in said at least said second processing path via said at least one generated phase adjustment signal.

20. The system according to claim 19, further comprising circuitry that generates at least one amplitude adjustment signal from outside said at least said second processing path.

21. The system according to claim 20, further comprising circuitry that adjusts an amplitude of said at least a portion of said received plurality of said spatially multiplexed communication signals, which are processed in said at least said second processing path via said at least one generated amplitude adjustment signal.

22. The system according to claim 19, further comprising a mixer that mixes a first signal generated by a voltage controlled oscillator (VCO) with said at least said portion of said received plurality of said spatially multiplexed communication signals, which are processed in said first reference processing path.

23. The system according to claim 22, further comprising a phase adjuster that modifies said first signal generated by said VCO with said at least one generated control signal.

24. The system according to claim 23, further comprising circuitry that generates said at least one phase adjustment signal by modifying said first signal generated by said VCO with said at least one generated control signal.

25. The system according to claim 24, further comprising circuitry that generates at least one amplitude adjustment signal by modifying said first signal generated by said VCO with said at least one generated control signal.

26. The system according to claim 19, wherein said generated said at least one control signal comprises a single weight signal.

27. The system according to claim 19, wherein said weight generator generates said at least one control signal utilizing at least one optimization algorithm comprising at least one of a maximum signal-to-noise ratio (SNR) algorithm, a maximum signal-to-interference-and-noise ratio (SINR) algorithm, and a minimum bit error rate (BER) algorithm.
